(19) United States
(12) Patent Application Publication
(10) Pub. No.: US 2017/0354217 A1
(43) Pub. Date: Dec. 14, 2017

(54) Luggage

(71) Applicant: Jasmine de Kotwara Taylor, Cambridge (GB)

(72) Inventors: Jasmine de Kotwara Taylor, Cambridge (GB); David Matthew Joseph Taylor, Cambridge (GB)

(21) Appl. No.: 15/619,466

(22) Filed: Jun. 10, 2017

(30) Foreign Application Priority Data
Jun. 13, 2016 (GB) 1610284.0

(51) Int. Cl. A45C 5/03; A45C 13/26; A45C 13/02; A45C 5/14; B62B 3/02; B62B 5/06

(52) U.S. Cl. CPC A45C 5/03; B62B 3/02; B62B 5/067; A45C 13/02; A45C 5/14; A45C 13/262; A45C 2005/037; A45C 2013/267; B62B 2202/24

(57) ABSTRACT

A case (1) comprises a shell (2) and a handle (4) moveable relative to the shell between a first position for carrying the case (1) and a second position for moving the case (1) over the ground (7), wherein the second position is further from the shell (2) than the first position. In the first position, the handle (4) is positioned substantially over the centre of gravity of the case (1) when the case (1) is in an orientation for moving the case (1) over an upwardly-facing surface (7).

### FIELD

The present invention relates to luggage, particularly wheeled luggage.

### BACKGROUND

A typical wheeled case includes a substantially cuboid shell, a set of wheels at one (“bottom”) face of the shell and a wheeling handle and a carrying handle at an opposite (“top”) face of the shell. The present invention seeks to provide an improved case.

### SUMMARY

According to a first aspect of the present invention, there is provided a case according to claim 1. Optional features are specified in the dependent claims.

### BRIEF DESCRIPTION OF THE DRAWINGS

Certain embodiments of the present invention will now be described, byway of example only, with reference to the accompanying drawings in which:

FIG. 1 illustrates a case with a handle in a wheeling position;

FIG. 2 illustrates the case of FIG. 1 with the handle in a carrying position;

FIG. 3 illustrates the case of FIG. 1 in a partially open position;

FIG. 4 illustrates the case of FIG. 1 in a fully open position with an inner part in a first position;

FIG. 5 illustrates the case of FIG. 1 in a fully open position with an inner part in an intermediate position; and

FIG. 6 illustrates the case of FIG. 1 in a fully open position with an inner part in a second position.

### DETAILED DESCRIPTION OF THE CERTAIN EMBODIMENTS

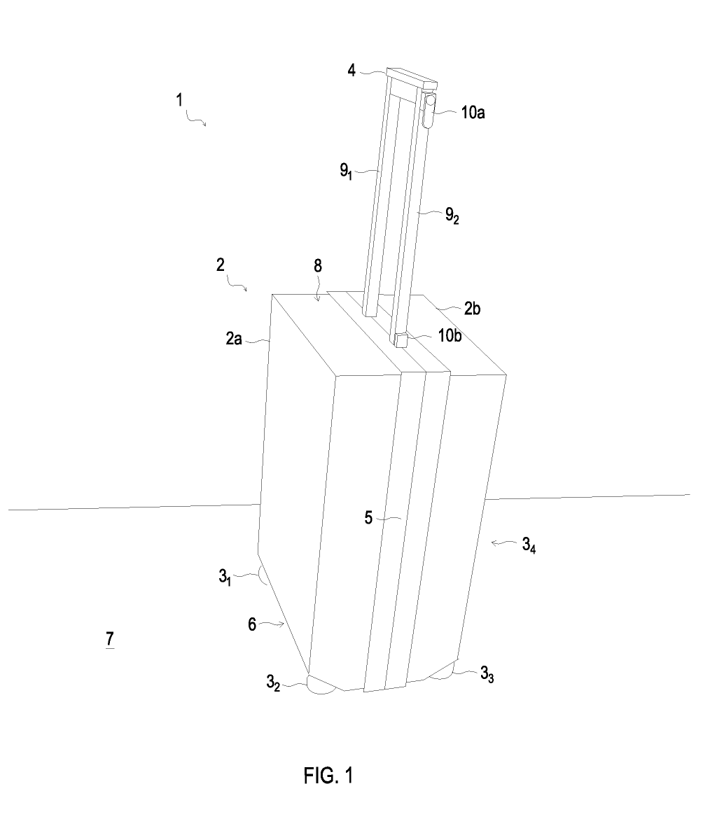

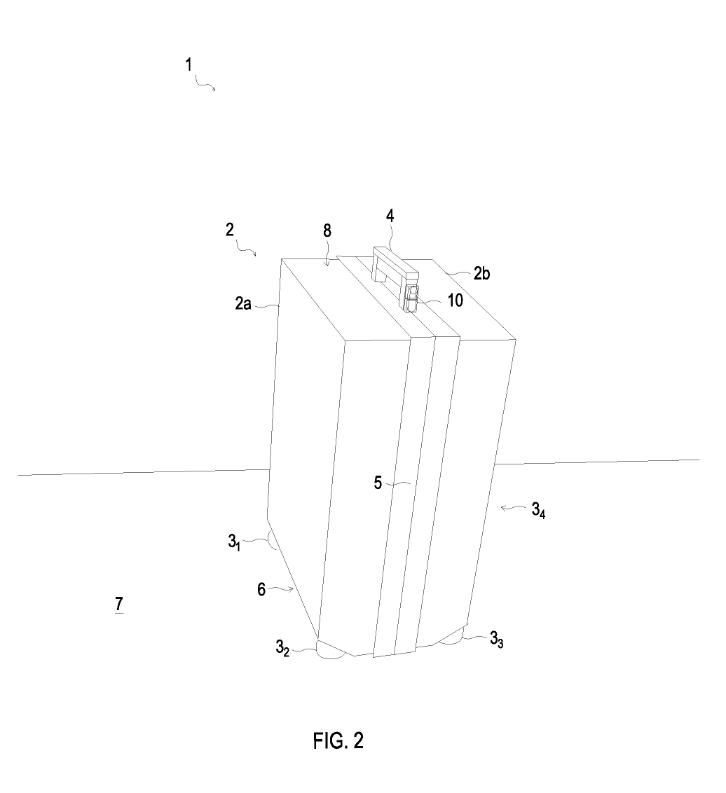

Referring to FIGS. 1 and 2, a case 1 will now be described.

The case 1 includes a substantially cuboid shell 2 to which are attached a set of wheels 3 and a handle 4.

The shell 2 comprises first and second shell parts 2a, 2b. The first and second shell parts 2a, 2b are connected to each other by a rotatable connection (represented by feature 5) to enable the shell 2 to be opened and closed. The rotatable connection 5 may include, for example, a set of hinges or a flexible part. A fastening device (not shown) is provided to enable the shell 2 to be fastened closed. The fastening device may include, for example, one or more catches or a zip.

The set of wheels 3 includes four wheels 3₁, 3₂, 3₃, 3₄ located on or near a (“lower”) face 6 of the shell 2. The case 1 can be oriented (“upright”) such that the four wheels 3 are in contact with a primarily upwardly-facing surface (“floor”) 7 and the case 1 can be moved over the floor 7 on the wheels 3. The case 1 can preferably be moved in any direction, for example by the wheels 3 being pivotably attached to the shell 2.

In other examples, there may be different numbers of wheels 3. For example, there may be two wheels 3. In such an example, the upright orientation corresponds to a stable orientation in which the two wheels 3 are in contact with, or in the vicinity of, the floor 7. From upright, such a case 1 can be tilted before being moved over the floor 7 on the two wheels 3.

The handle 4 is preferably located on or near an (“upper”) face 8 of the shell 2 opposite to the lower face 6. The handle 4 is movable relative to the shell 2 between at least a first (“wheeling”) position and a second (“carrying”) position. In FIG. 1, the handle 4 is shown in the wheeling position. In FIG. 2, the handle 4 is shown in the carrying position. The handle 4 is further from the shell 2 in the wheeling position than in the carrying position. Thus, in the wheeling position, the handle 4 can be more conveniently used to wheel the case 1. For example, the handle 4 may be more than 10 cm or more than 20 cm or more than 30 cm or more than 40 cm from the shell 2 in the wheeling position. The handle 4 may be a distance of about 1 metre from the floor 7 when the handle 4 is in the wheeling position and the case 1 is upright. In the carrying position, the handle 4 can be more conveniently used to carry the case 1 off the floor 7. For example, the handle 4 may be a distance of several centimetres from the (upper face 8 of the) shell 2 in the carrying position. The handle 4 is positioned substantially over the centre of gravity of the case 1 when the case 1 is in the upright position. By this, it is meant that the centre of the handle 4 is within 6 cm, more preferably within 3 cm, more preferably within 2 cm, more preferably within 1 cm and more preferably within 0.5 cm of a vertical line passing through the centre of gravity of the case 1 when the case 1 is in the upright position and when the case 1 is empty of additional contents.

The handle 4 is preferably attached to the remainder of the case 1 via a set of one or more elongate members (“stems”) 9. In this example, there are two stems 9₁,9₂. The stems 9 are extendable (e.g. telescopic) and/or are slidably attached to the remainder of the case 1 to enable the handle 4 to move between the wheeling and carrying positions.

The case 1 preferably includes a device (“latch”) 10 to releasably hold the handle 4 in the carrying position. With the case 1 upright and the handle 4 initially in the carrying position, applying a sufficient “lifting” force (i.e. in a direction away from the floor 7) to the handle will lift the case 1 off the floor 7 if the latch 10 is not released, and will cause the handle 4 to move to the wheeling position if the latch 10 is released. The latch 10 preferably automatically deploys to hold the handle 4 when the handle 4 returned to the carrying position. The latch 10 is preferably positioned relative to the handle 4 such that it can be operated by a user's hand (e.g. by a finger or thumb on that hand) when the handle 4 is in the carrying position without removing that hand from the handle 4. For instance, the latch 10 may include first and second latch parts 10a, 10b, one of which is attached to the handle 4 or to a stem 9 and the other of which is attached to the remainder of the case 1. The first latch part 10a may include a movable part that is urged so as to engage with a corresponding part in the second latch part 10b when the handle 4 is in the carrying position, while a button can be used to disengage the parts 10a, 10b.

Thus, a user can readily switch between carrying and wheeling the case 1 and preferably without removing their hand from the handle 4. Because the handle 4 is positioned substantially over the centre of gravity of the case 1 when the case 1 is in the upright position, the case 1 does not tilt substantially during this switch which is therefore a particularly comfortable and safe procedure.

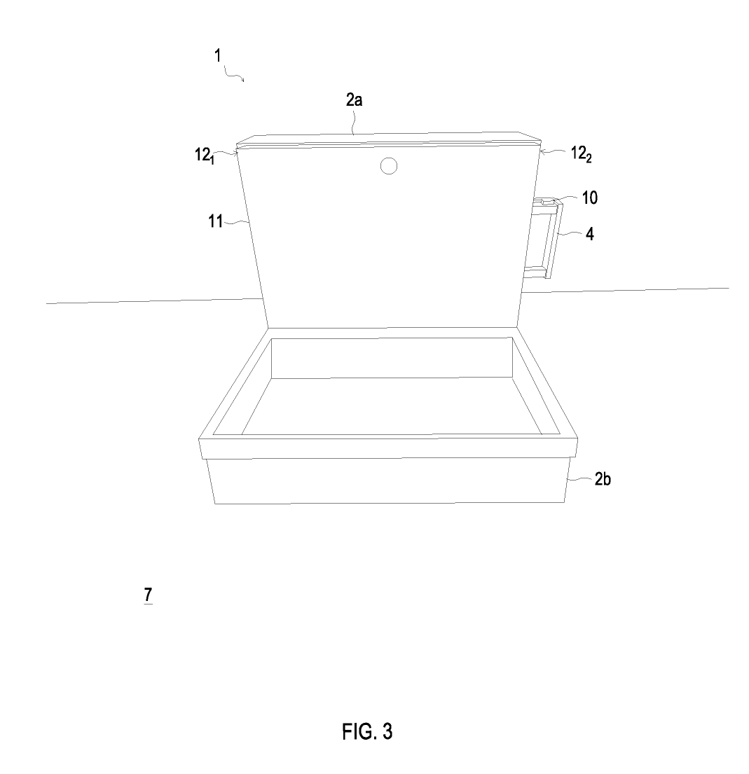

Referring to FIG. 3 to 6, further features 11 etc. of the case 1 will now be described. These further features 11 are optional. FIG. 3 shows the case 1 positioned with a major face of the second shell part 2b on the floor 7 and in a partially open position. The case 1 has a substantially cuboid inner part 11 to which are attached the stems 9₁, 9₂ and, in this example, a part of the latch 10. The inner part 11 preferably fits inside the shell 2. The shell 2 is preferably provided with cut outs (not shown) to enable the stems 9₁, 9₂ etc. to pass through the shell 2 (and to enable the first and second shell parts 2a, 2b and the inner part 11 to be rotated relative to one another as described below). The inner part 11 has an interior volume which houses those parts of the stems 9₁, 9₂ that need to be housed depending upon the position of the handle 4. Thus, the stems 9₁, 9₂ do not interfere with any contents (clothes etc.) in the case 1.

When the case 1 is closed, the inner part 11 preferably divides the volume inside the shell 2 into two parts, one of which (“the first volume”) is primarily within the first shell 2a and the other of which (“the second volume”) is primarily within the second shell 2b. The inner part 11 is preferably held in such a position by, for example, the shape of the first and shell parts 2a, 2b or additional components of the case 1. The inner part 11 is connected to the first and/or second shell parts 2a, 2b by a rotatable connection (not shown). The first and second shell parts 2a, 2b and the inner part 11 preferably all rotate relative to one another about substantially the same axis of rotation. For instance, the first and second shell parts 2a, 2b may be connected to each other by a first set of hinges (not shown). One of the shell parts, e.g. the first shell part 2a, and the inner part 11 may be connected to each other by a second set of hinges (not shown) aligned with the first set of hinges.

This alignment may be achieved by providing cut outs in the other shell part, e.g. the second shell part 2b, to enable the second set of hinges to be connected, e.g. via connecting parts provided in the cut outs, to the inner part 11.

The case 1 preferably includes a device (“catches”) 12, e.g. ball catches, to releasably hold the inner part 11 in a substantially fixed (“first”) position relative to the first shell part 2a as the case is initially opened. Thus, when the case is opened as shown in FIG. 3, any contents contained in the first volume is held in place by the inner part 11.

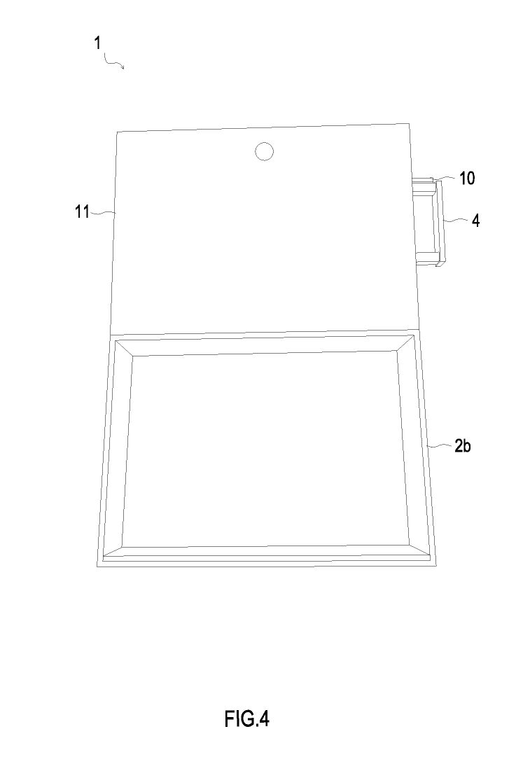

FIG. 4 shows the case in a fully open position with the inner part 11 still in the first position relative to the first shell part 2a. In this first position (as in the partially open position shown in FIG. 3), content can be packed into or unpacked from the second volume.

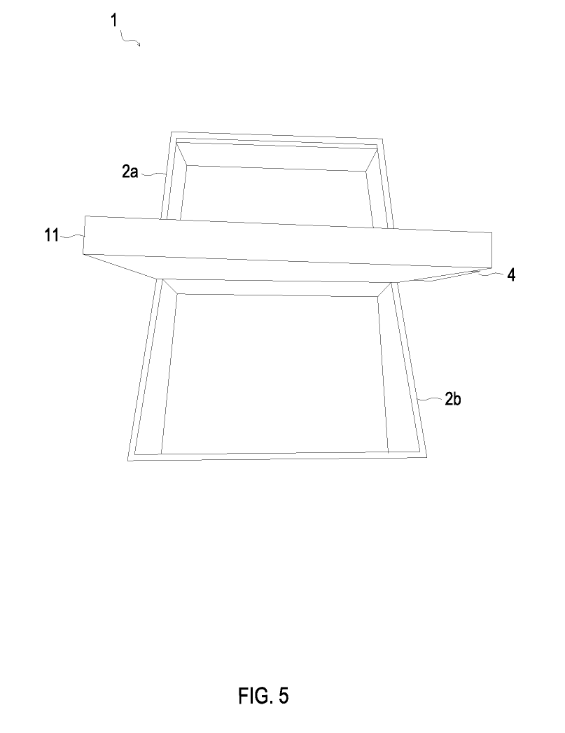

FIG. 5 shows the inner part 11 after it has been moved relative to the first shell part 2b (by a force to overcome the holding force of the catches) to an intermediate position.

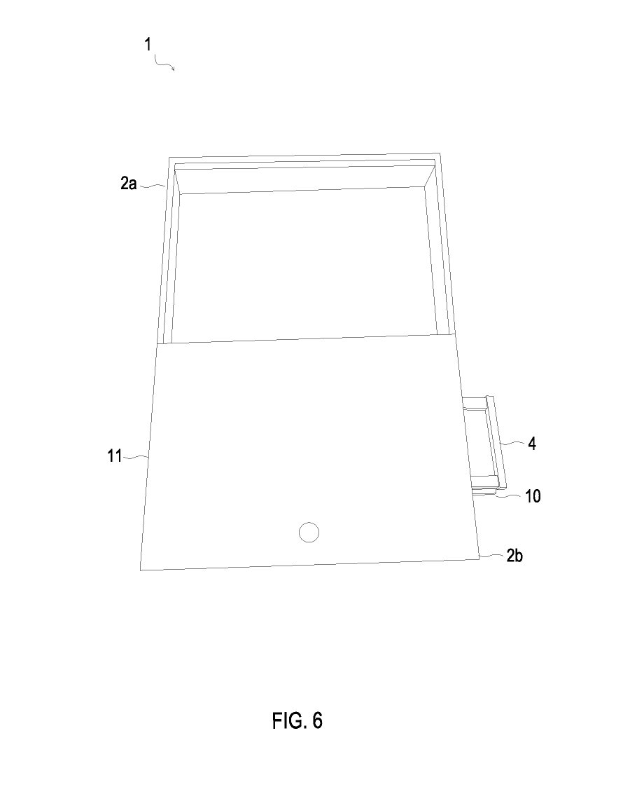

FIG. 6 shows the inner part 11 after it has been moved to a second, resting position over the second volume. In this second position, content can be packed into or unpacked from the first volume.

In order to close the case 1, the inner part 11 is moved from the second position back to the first position so that the catch 12 holds the inner part 11 and the first shell part 2a is then rotated relative the floor 7, i.e. via the position shown in FIG. 3.

Thus, the user can separately pack two volumes of the case 1, which may be substantially equal, and the inner part 11 holds contents in place against gravity. Moreover, the second volume is revealed but the first volume is not revealed when the case 1 is initially opened and so a user can pack different contents in the different volumes according to different needs (e.g. accessibility, privacy).

The volume enclosed by the inner part 11 not taken up by housing the stems 9₁, 9₂ can be used to provide compartments which can be configured so that they are accessible when the inner part 11 is in the first and/or second positions. Thus, maximum use can be made of the volume inside the case 1.

It will be appreciated that many modifications can be made to the embodiments described above.

For example, the case 1 need not be substantially cuboid and the shapes of the shell parts 2a, 2b and the inner part 11 may differ accordingly. The case 1 need not have the illustrated aspect ratio.

The inner part 11 need not completely divide the case 1 into the first and second volumes. For example, the inner part 11 may have cut outs connecting the first and second volumes and/or may only extend as far as is required to house the stems 9.

The rotatable connection 5 may be provided on the upper or lower face 6, 8 of the shell 2 rather than on a different face as shown.

The inner part 11 need not fit fully inside the first and second shell parts 2a, 2b. For instance, the inner part 11 may be sandwiched between the first and second shell parts 2a, 2b so that it is visible at the exterior of the case 1. In this case in particular, the first and second shell parts 2a, 2b and the inner part 11 need not all rotate relative to one another about substantially the same axis of rotation.

References to upright etc. apply in a corresponding way if the case is being used on inclined surface.

1. A case comprising:
a shell; and
a handle moveable relative to the shell between a first position for carrying the case and a second position for moving the case over the ground, wherein the second position is further from the shell than the first position;
wherein, in the first position, the handle is positioned substantially over the centre of gravity of the case when the case is in an orientation for moving the case over an upwardly-facing surface.

2. A case according to claim 1, wherein the case comprises a set of wheels for moving over the surface.

3. A case according to claim 2, wherein the orientation for moving the case over the surface corresponds to an orientation in which each of the set of wheels is in contact with the surface.

4. A case according to claim 2, wherein the orientation for moving the case over the surface corresponds to a stable orientation of the case in which each of the set of wheels is in contact with, or in the vicinity of, the surface, and from which the case can be tilted before being moved over the surface.

5. A case according to claim 1, comprising a device to releasably hold the handle in the first position.

6. A case according to claim 5, wherein the device is positioned such that it can be operated by a user's hand without removing that hand from the handle when the handle is in the first position.

7. A case according to claim 5, wherein the device is configured to automatically deploy to hold the handle in the first position when the handle is returned to the first position.

8. A case according to claim 1, wherein the shell comprises first and second shell parts.

9. A case according to claim 8, comprising:
first and second shell parts constituting the shell;
a set of elongate members to which the handle is attached; and
an inner part to which the set of elongate members is attached.

10. A case according to claim 9, wherein the inner part is substantially contained with the first and second shell parts.

11. A case according to claim 9, wherein the inner part divides the volume inside the shell into first and second volumes.

12. A case according to claim 11, wherein the first and second volumes are substantially equal.

13. A case according to claim 9, wherein the first and second shell parts and the inner part are rotatable relative to one another.

14. A case according to claim 13, wherein the first and second shell parts and the inner part are rotatable relative to one another about substantially the same axis of rotation.

15. A case according to claim 13, wherein the inner part is releasably held in a fixed position relative to one of the shell parts when the case is opened so as to hold contents in place against gravity when the case is being opened or closed by rotating the one shell part.

16. A case according to claim 13, wherein the inner part divides the volume inside the shell into first and second volumes, wherein the inner part is rotatable relative to the first and second shell parts between two stable positions so as to enable content to placed into, or removed from, the first or the second volume.

17. A case according to claim 9, wherein at least a portion of the set of elongate members are housed within the inner part.

18. A case according to claim 9, wherein the inner part comprises compartments.
